(19) United States
(12) Patent Application Publication
(10) Pub. No.: US 2014/0372231 A1
(43) Pub. Date: Dec. 18, 2014

(54) ONLINE SELLING MECHANISM CREATION

(71) Applicant: Microsoft Corporation, Redmond, WA (US)

(72) Inventors: Kfir Karmon, Tel Aviv (IL); Karen Master Ben-Dor, Tel Aviv (IL); Yagil Engel, Tel Aviv (IL); Adi Diamant, Tel Aviv (IL); Moshe Tennenholtz, Haifa (IL); Haim Somech, Ramat Gan (IL)

(73) Assignee: Microsoft Corporation, Redmond, WA (US)

(21) Appl. No.: 13/918,337

(22) Filed: Jun. 14, 2013

(51) Int. Cl. G06Q 30/02

(52) U.S. Cl. CPC G06Q 30/0276
USPC 705/14.72

(57) ABSTRACT

Online selling mechanism creation is described, for example, whereby a retailer with business goals and constraints benefits from automatic generation and execution of software which controls generation of online offers so as to meet the business goals within the constraints. For example, as business goals and constraints change over time, bespoke selling mechanisms may be automatically updated. In various examples business goals are used to select selling mechanisms from a plurality of available online selling mechanisms; properties of the selling mechanisms may be taken into account. In examples, generic software implementing the selling mechanisms is used to instantiate a bespoke selling mechanism according to particular business goals and constraints. For example, a bespoke selling mechanism may be executed at a commerce server so as to control dynamic generation of offers.

### BACKGROUND

Online selling mechanisms such as online auctions, direct sales web sites, advertisement systems and other online selling mechanisms are time consuming and expensive for marketeers to create and configure. For example, if a marketeer, such as a retailer of computing equipment, desires to set up an online auction he or she has a lengthy design and implementation process. The type of auction and the auction mechanism are to be selected, tested and implemented. Once this is achieved it is difficult to change or modify the particular selling mechanism that is implemented. Retailers may miss out on potential sales, or obtain suboptimal value, by selecting sub-optimal selling mechanisms and/or by not updating the selling mechanisms as the market and the retailer's own constraints change over time.

Existing online selling mechanisms implement single types of selling mechanism such as standard auctions, direct sales sites and group buying sales sites. These existing online selling mechanisms tend to be separate and dedicated to particular types of retailer requirements.

The embodiments described below are not limited to implementations which solve any or all of the disadvantages of known online selling mechanisms.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Online selling mechanism creation is described, for example, whereby a retailer with business goals and constraints benefits from automatic generation and execution of an automated selling mechanism so as to meet the business goals within the constraints. For example, as business goals and constraints change over time, bespoke selling mechanisms may be automatically updated. In various examples business goals are used to select selling mechanisms from a plurality of available online selling mechanisms; properties of the selling mechanisms may be taken into account. In examples, generic software implementing the selling mechanisms is used to instantiate a bespoke selling mechanism according to particular business goals and constraints. For example, a bespoke selling mechanism may be executed at an advertising server so as to control dynamic generation of advertisements.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a configuration and customization component arranged to create a bespoke online selling mechanism;

FIG. 2 is a schematic diagram of a configuration and customization component connected to a commerce mechanism at a commerce server;

FIG. 3 is a flow diagram of a method of operation at a configuration and customization component;

FIG. 4 is a flow diagram of another method of operation at a configuration and customization component;

FIG. 5 is a schematic diagram of three commerce mechanism displays;

FIG. 6 illustrates an exemplary computing-based device in which embodiments of a configuration and customization component for creation of online selling mechanisms may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

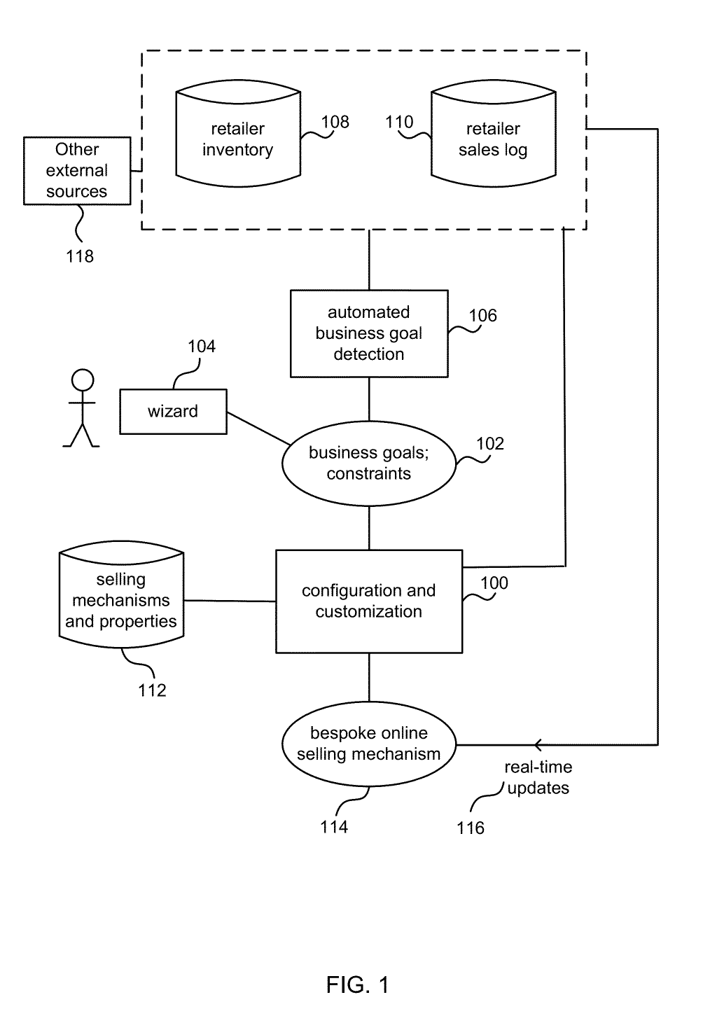

FIG. 1 is a schematic diagram of a configuration and customization component 100 arranged to create a bespoke online selling mechanism 114 and optionally to enable the bespoke online selling mechanism to be updated and/or modified dynamically.

The configuration and customization component 100 is computer implemented using software and/or hardware. It has access to a database 112 of selling mechanisms and selling mechanism properties. The selling mechanisms are in the form of software implementing algorithms, rules and/or criteria which may be used to control the generation of sales offers in the form of online offers. Examples of selling mechanisms at the database 112 include but are not limited to: price optimization algorithms, auction rules and algorithms, product substitution algorithms, product bundling processes, group buying processes, raffle processes and bilateral negotiation rules and algorithms. Each of the different selling mechanisms may have many different configurable properties which are also stored at the database 112. For example, an auction may have properties that include but are not limited to: auction interaction protocol, bid expressiveness, closing rules, allocation rules, pricing rules, and parameters such as floor price, price increments and price decrements.

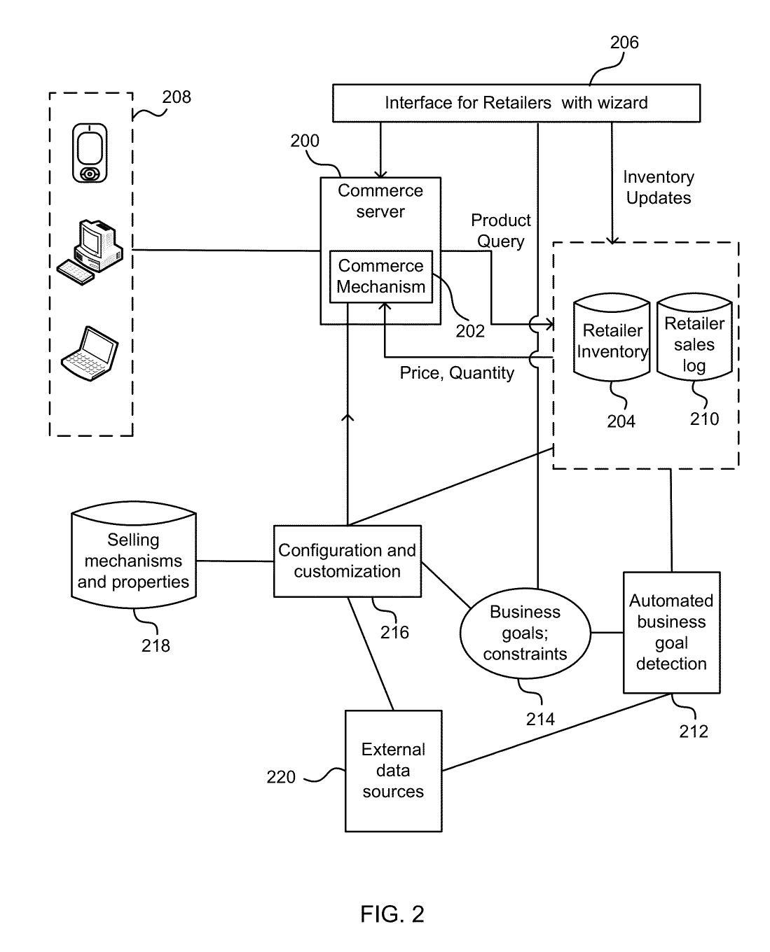

The configuration and customization component 100 receives any one or more of: business goals and constraints 102, data from a retailer inventory 108, data from a retailer sales log 110, data from external sources 118. In some examples it maps the business goals and constraints to the selling mechanisms and properties and as a result is able to produce a bespoke online selling mechanism 114. In some examples the configuration and customization component 100 produces a bespoke online selling mechanism on the basis of any one or more of: business goals and constraints 102, data from a retailer inventory 108, data from a retailer sales log 110, data from external sources 118. The external sources are described in more detail with reference to FIG. 2 below.

A business goal is an aim of a marketeer with respect to one or more specified products or an inventory of products. For example, a business goal may be to sell specified products in a retailer inventory for a maximum revenue. A constraint is a specified limit, threshold or criterion to be applied to a business goal. For example, a constraint may be a time period during which offers for sale may be made. A constraint may be a quantity of products which are available for sale. A constraint may be a floor price. Other examples of constraints are also possible.

The online selling mechanism 114 comprises software implementing particular algorithms, rules and/or criteria (from the database 112) which control the generation of sales offers in the form of online offers. The software of the online selling mechanism 114 may be used together with a commerce server as described with reference to FIG. 2. In this way the bespoke online selling mechanism 114 may be automatically created and put into operation without the need for significant expertise, time, expense and effort on the part of a retailer or other marketeer.

The business goals and constraints 102 may be obtained in a number of different ways. For example, software implementing a wizard 104 may be used to determine the business goals and constraints. The wizard 104 comprises a graphical user interface which may present a series of questions to a marketeer according to rules or other criteria. According to answers the marketeer inputs to the graphical user interface, subsequent questions are tailored to enable business goals and constraints to be identified in a simple, fast manner. This may be achieved by using a rule base, a decision tree or using another type of reasoning tool which is able to select questions to be presented from a store of questions, or to dynamically generate questions.

The answers provided by the marketeer may be stored at the wizard 104 or another location.

In some examples the marketeer provides access to a retailer inventory 108 and, optionally also to a retailer sales log. A retailer inventory 108 is a database or any other store holding data about products a retailer has in stock available for sale. The data about the products may comprise prices, product descriptions, products which may be substituted for other products, product sources, numbers of products in stock, product expiry dates.

In the example of FIG. 1 a single retailer inventory 104 is illustrated for clarity. However, in practice many retailer inventories may be present. A single retailer inventory may comprise product data of products stocked by more than one retailer.

A retailer sales log is a database or any other store holding data about requests to purchase products. For example, it may store information about purchase requests such as product identifiers, prices, billing details, delivery details, time and date of purchase/sale, delivery methods, quantity, original price, discounted price and other information.

In some examples an automated business goal detection component 106 is provided. This component is implemented using software and/or hardware and is arranged to access data from any one or more of: the retailer inventory 108, the retailer sales log 110, external sources. External sources may be automated calendars, information retrieval logs, web history logs or others. Using the accessed data the automated business goal detection component 106 checks for pre-specified criteria or conditions which are associated with particular business goals. On the basis of the checks it is able to determine business goals which are appropriate for the current state of the retailer inventory and/or sales log. The determined business goals may be suggested to the marketeer, for example, by being presented at a graphical user interface. The marketeer may be given an opportunity to accept or reject the suggested business goals. The determined business goals may be used together with, or in place of, the business goals from the wizard 104. In some examples calendar events, information retrieval events or trends, and web usage events or trends may be used to influence business goals and/or the configuration and customization process.

In examples where a retailer inventory 108 and/or retailer sales log 110 are available, data from those sources may be used to provide real time updates 116 to the bespoke online selling mechanism 114. This is now explained with reference to FIG. 2.

FIG. 2 is a schematic diagram of a configuration and customization component 216 connected to a commerce mechanism 202 at a commerce server 200. The configuration and customization component 216 is an example of the configuration and customization component of FIG. 1; it produces as output a bespoke online selling mechanism comprising software integral with the commerce mechanism 202. For example, the configuration and customization component may comprise software in generic form for implementing a plurality of different online selling mechanisms. The output of the configuration and customization component may be a particular instantiation of the generic software which is tailored for a particular situation according to particular business goals 214 and constraints. The particular instantiation of the generic software may be executed at the commerce mechanism 202.

The software in generic form for implementing the plurality of different online selling mechanisms may be stored at the configuration and customization component 216 or at one or more stores 218 which hold selling mechanisms and their properties.

The business goals and constraints 214 are output by either or both of a wizard (which is integral with an interface for retailers 206 in this example) and an automated business goal detection component 212 which is the same as the automated business goal detection component 106 of FIG. 1. The automated business goal detection component 212 and the configuration and customization component 216 may use data from external sources 220.

The commerce mechanism 202 is illustrated in FIG. 2 as being integral with a commerce server 200 although that is not essential; the commerce mechanism may be separate from the commerce server and located at another entity which is in communication with the commerce server over a communications network of any type. The commerce mechanism 202 and the commerce server 200 are both computer implemented using software and/or hardware. In some examples the commerce server is a web server publishing a retailer web site.

The commerce mechanism 202 is arranged to control the creation and output of online offers from the commerce server 200 according to the bespoke online selling mechanism 114. The commerce mechanism 202 may be updated or changed over time as any one or more of: the business goals and constraints 214, the retailer inventory, the retailer sales log, and data from the external data sources 220 change. This is achieved by using the configuration and customization component 216 to output a new bespoke online selling mechanism 114 to the commerce mechanism 202.

The commerce server is arranged to send offers to an end user device 208 such as a smart phone, a personal computer, a laptop computer or any other end user computing device which is able to display offers.

In the example illustrated in FIG. 2 the commerce server 200 is in communication with a retailer inventory 204 and a retailer sales log 210. However, this is not essential. In some examples, the commerce server 200 operates to dynamically generate offers according to the commerce mechanism 202, without obtaining data from the retailer inventory 204 and/or retailer sales log 210. For example, where the commerce mechanism implements a dynamic pricing model which does not take retail inventory or retail sales data as input.

In examples where a retailer inventory 204 and/or a retailer sales log 210 are available, the commerce server 200 is arranged to send queries to the retailer inventory 204 and/or retailer sales log 210 in order to obtain inventory and/or sales data. For example, the commerce server 200 is able to send a product query comprising a product identifier to the retailer inventory and/or sales log. The retailer inventory and/or sales log generates a response to the query comprising data related to the product. For example, price data, quantity data, data about demand for the product, and other data. The responses may be used by the commerce mechanism 202 to control the dynamic generation of offers.

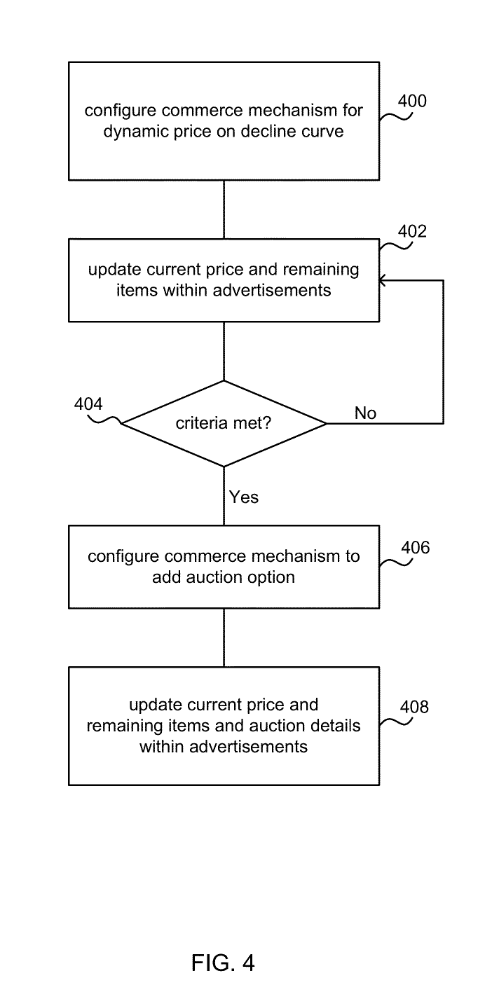

FIG. 3 is a flow diagram of a method of operation at a configuration and customization component such as that of FIG. 1 and FIG. 2. The configuration and customization component accesses 300 business goals and constraints from a wizard and/or from a process which determines the business goals and constraints from a retailer inventory and/or sales log. The configuration and customization component maps 302 the business goals and constraints to selling mechanism properties and in so doing identifies selling mechanisms which may be used. The identified selling mechanisms are configured 304 by instantiating an instance of the identified selling mechanism software from the generic software. The software instance is customized according to the constraints. The configured and customized software may then be executed at the commerce mechanism in order to operate 308 the bespoke selling mechanisms. As new business goals and/or constraints are identified the process may repeat to enable the bespoke selling mechanism to dynamically adjust.

In some examples, the configuration and customization component carries out additional configuration and customization on the basis of data from any one or more of: the retailer sales log, the retailer inventory, external data sources.

In some examples the configuration and customization component generates the bespoke selling mechanism using only retailer inventory and/or sales log data.

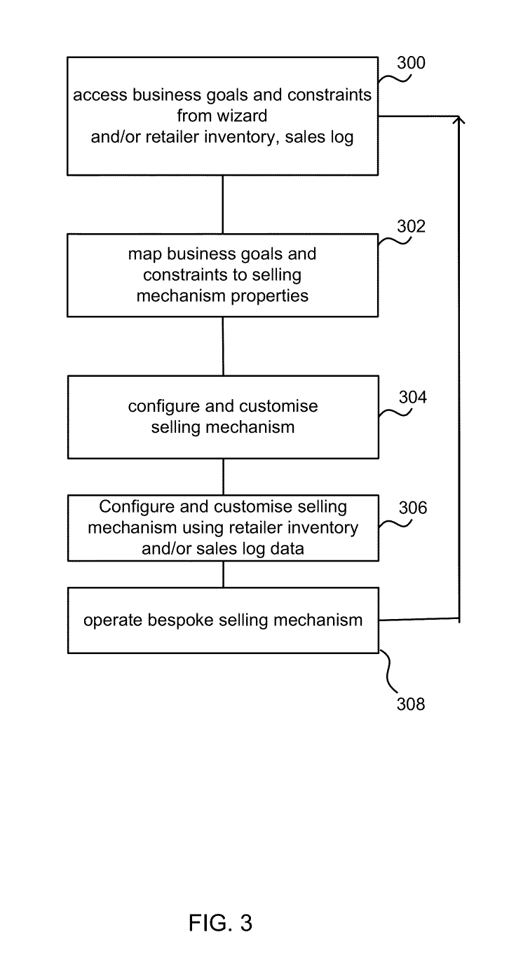

FIG. 4 is a flow diagram of a method of operation at a configuration and customization component for a scenario where a marketeer has 1000 laptops to be sold within four weeks. This example is given to illustrate one way in which the configuration and customization component may be used and it is not intended to limit the operation of the system to these particular business goals and constraints.

For example, the business goals and constraints of a particular marketeer may be that an inventory of 1000 laptops is to be sold within four weeks where the marketeer has set a floor price of $490 per laptop and where the current market price is known to be $697. These business goals and constraints are used by the configuration and customization component to produce a bespoke selling mechanism which, in this example, comprises two phases. A first phase during which the laptops are to be offered for sale using dynamic pricing starting at the market price; and a second phase during which the laptops are to be offered for sale in an auction (in addition to the offer for sale using dynamic pricing). The second phase is to occur when demand is reduced to a threshold level and/or after a specified time.

The bespoke selling mechanism is instantiated from the generic software at the configuration and customization component 216 and executed at the commerce mechanism 202. For example, during the first phase the configuration and customization component configures 400 the commerce mechanism to use a dynamic price. This may be a dynamic price determined on a decline curve. For example, the price displayed in an offer generated during the first phase varies according to the time elapsed since the start of the four week selling period. During the first phase the commerce mechanism updates 402 the current price and a remaining number of laptops within the dynamic offers.

For example, during the first phase, an offer request may be received at the commerce server 200 of FIG. 2. The offer request may comprise an identifier of a marketeer and/or product. The offer request may comprise an identifier of a design.

The commerce server accesses a design which is associated with the offer request. For example, it selects a design input by the identified marketeer for an identified product. It may select a design which is specified in the request.

The commerce mechanism uses the software which has been configured and customized to implement the bespoke selling mechanism. It determines whether any data is to be obtained from sources such as the retailer inventory or sales log. If so, it formulates one or more queries to send to the external sources to obtain the data and it receives the query responses. It calculates dynamically any prices or other calculated quantities to be populated in the offer, using the data obtained from external sources and/or other data.

Using the selected design and the calculated and/or accessed data the commerce server creates an offer.

If criteria are met 404 for the second phase, such as a specified time has elapsed, the configuration and customization component configures the commerce mechanism to add 406 an auction option. During the second phase, when the auction option is also available, the commerce mechanism updates 408 the current price and the remaining number of laptops in the dynamic offers. It also generates auction details and includes those in the dynamically generated offers. For example, the auction details may comprise a dynamically generated floor price for the auction.

In this example, when an offer request is received by the commerce server 200 a dynamic offer is created by the commerce server according to the bespoke selling mechanism. For example, during the first phase of the four week period offers are created which display a current price which is determined by the commerce mechanism 202 using a dynamic pricing model. That is, the price displayed in an offer generated during the first phase varies according to the time elapsed since the start of the four week selling period.

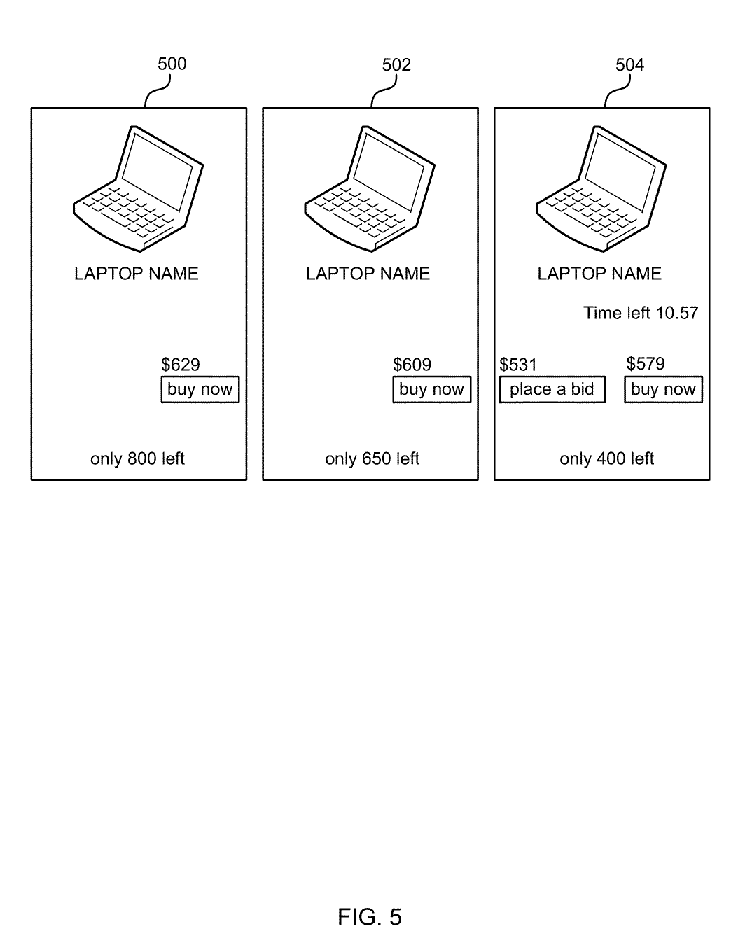

FIG. 5 is a schematic diagram of three mechanism displays 500, 502, 504. For example, during the first phase of the example of FIG. 4 a dynamically generated offer as in display 500 may be used. This display shows a picture of the type of laptop being offered for sale and states a price and a quantity of laptops remaining. Later in time during the first phase of the example of FIG. 4 a dynamically generated offer as in display 502 may be used. This is similar to display 500 but now the stated price is lower because the price is dynamically calculated according to the elapsed time. Also the number of laptops remaining is lower as some have now been sold.

During a second phase of the example of FIG. 5 a dynamically generated offer as in display 504 may be used. This display is similar to those of 500 and 502 but now the display includes a stated remaining time of the promotion or sales period. The display also includes a stated floor price of an auction and offers an opportunity to place a bid in the auction for one of the laptops. The price to purchase one of the laptops without using the auction is stated as before and is now lower as more time has elapsed. The quantity of remaining laptops is also lower.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

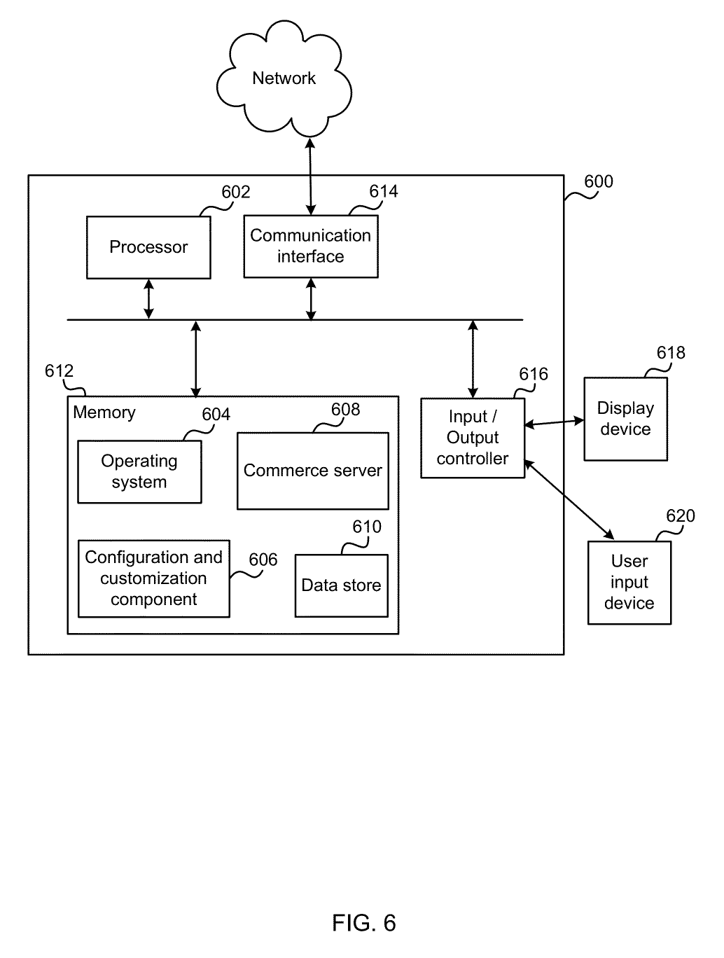

FIG. 6 illustrates various components of an exemplary computing-based device 600 which may be implemented as any form of a computing and/or electronic device, and in which embodiments of a configuration and customization component for online selling mechanisms may be implemented.

Computing-based device 600 comprises one or more processors 602 which may be microprocessors, controllers or any other suitable type of processors for processing computer executable instructions to control the operation of the device in order to dynamically generate software implementing bespoke online selling mechanisms. In some examples, for example where a system on a chip architecture is used, the processors 602 may include one or more fixed function blocks (also referred to as accelerators) which implement a part of the method of dynamically generating offers using retailer inventory data in hardware (rather than software or firmware). Platform software comprising an operating system 604 or any other suitable platform software may be provided at the computing-based device to enable application software to be executed on the device. The computer executable instructions may give functionality of a commerce server 608 and a configuration and customization component 606 able to carry out the methods described herein.

The computer executable instructions may be provided using any computer-readable media that is accessible by computing based device 600. Computer-readable media may include, for example, computer storage media such as memory 612 and communications media. Computer storage media, such as memory 612, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 612) is shown within the computing-based device 600 it will be appreciated that the storage may be distributed or located remotely and accessed via a network or other communication link (e.g. using communication interface 614).

The computing-based device 600 also comprises an input/output controller 616 arranged to output display information to a display device 618 which may be separate from or integral to the computing-based device 600. The display information may provide a graphical user interface. The input/output controller 616 is also arranged to receive and process input from one or more devices, such as a user input device 620 (e.g. a mouse, keyboard, camera, microphone or other sensor). In some examples the user input device 620 may detect voice input, user gestures or other user actions and may provide a natural user interface (NUI). This user input may be used to input designs, set criteria, rules or thresholds, specify an address of a retailer inventory, specify business goals and constraints, specify selling mechanisms and their properties and for other purposes. In an embodiment the display device 618 may also act as the user input device 620 if it is a touch sensitive display device. The input/output controller 616 may also output data to devices other than the display device, e.g. a locally connected printing device.

Any of the input/output controller 616, display device 618 and the user input device 620 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method comprising:
receiving at a processor data comprising any one or more of: a business goal, a business constraint, retailer inventory data, retailer sales log data;
configuring and customizing at least one selling mechanism from a plurality of available online automated selling mechanisms, on the basis of the received data;
executing the configured and customized selling mechanism to control generation of offers by a commerce server.

2. A method as claimed in claim 1 comprising receiving a business goal and a business constraint from a software wizard arranged to receive input from a marketeer in response to a series of questions.

3. A method as claimed in claim 1 comprising receiving a business goal and a business constraint from an automated process which analyses a retailer inventory and/or a retailer sales log.

4. A method as claimed in claim 1 comprising receiving an update to the received data; and dynamically reconfiguring and re-customizing the at least one selling mechanism on the basis of the update.

5. A method as claimed in claim 1 wherein configuring and customizing the at least one selling mechanism comprises selecting the at least one selling mechanism from the plurality of available online automated selling mechanisms according to the received data.

6. A method as claimed in claim 1 wherein configuring and customizing the at least one selling mechanism comprises taking into account properties of the available online automated selling mechanisms.

7. A method as claimed in claim 1 wherein configuring and customizing the at least one selling mechanism comprises instantiating the at least one selling mechanism from generic software specifying the plurality of available online automated selling mechanisms.

8. A method as claimed in claim 1 wherein the plurality of available online automated selling mechanisms comprise any two or more of: price optimization algorithms, auction algorithms, product substitution algorithms, product bundling processes, group buying processes, raffle processes, bilateral negotiation algorithms, commercially-driven tournaments.

9. A method as claimed in claim 1 comprising receiving a business constraint which is a time period for execution of the configured and customized selling mechanism.

10. A method as claimed in claim 1 comprising receiving a business constraint which is a floor price.

11. A method as claimed in claim 1 comprising receiving a constraint which is a number of products.

12. A method as claimed in claim 1 wherein the configured and customized selling mechanism comprises a plurality of selling mechanisms arranged to be executed according to different criteria.

13. A computer-implemented method comprising:
receiving at a processor data comprising any one or more of: a business goal, a business constraint, retailer inventory data, retailer sales log data;
configuring and customizing at least one selling mechanism from a plurality of available online automated selling mechanisms, on the basis of the received data;
executing the configured and customized selling mechanism to control generation of offers by a commerce server;
receiving an update to the at received data; and dynamically reconfiguring and re-customizing the at least one selling mechanism on the basis of the update.

14. A method as claimed in claim 13 wherein configuring and customizing the at least one selling mechanism comprises instantiating the at least one selling mechanism from generic software specifying the plurality of available online automated selling mechanisms.

15. A configuration and customization component comprising:
a processor arranged to receive data comprising any one or more of: a business goal, a business constraint, retailer inventory data, retailer sales log data;
the processor arranged to configure and customize at least one selling mechanism from a plurality of available online automated selling mechanisms, on the basis of the received data;
the processor arranged to execute the configured and customized selling mechanism to control generation of offers by a commerce server.

16. A configuration and customization component as claimed in claim 15 which is integral with a commerce server.

17. A configuration and customization component as claimed in claim 15 comprising the plurality of available online automated selling mechanisms.

18. A configuration and customization component as claimed in claim 15 comprising a software wizard arranged to receive input from a marketeer in response to a series of questions and to determine at least one business goal and at least one business constraint from the received input.

19. A configuration and customization component as claimed in claim 15 comprising an automated process which analyses a retailer inventory and/or a retailer sales log to obtain the received data.

20. A configuration and customization component being at least partially implemented using hardware logic selected from any one or more of: a field-programmable gate array, a program-specific integrated circuit, a program-specific standard product, a system-on-a-chip, a complex programmable logic device.
